(19) United States
(12) Patent Application Publication
(10) Pub. No.: US 2017/0321724 A1
(43) Pub. Date: Nov. 9, 2017

(54) SUBMERSIBLE PNEUMATIC PUMP WITH AIR EXCLUSION VALVE

(71) Applicant: Michael Kevin Breslin, Mill Valley, CA (US)

(72) Inventor: Michael Kevin Breslin, Mill Valley, CA (US)

(21) Appl. No.: 15/145,707

(22) Filed: May 3, 2016

(51) Int. Cl. F04F 1/06; F16K 1/14; F16K 15/04; F16K 31/20

(52) U.S. Cl. CPC F04F 1/06; F16K 31/20; F16K 1/14; F16K 15/04

(57) ABSTRACT

A submersible pneumatic canister pump system for pumping liquid from a tank or underground location by incorporating a floating ball valve inside the pump for preventing air from exiting with the liquid discharge. The floating ball valve is located near the lower end of the pump and communicates with the discharge pipe. When liquid level approaches the lower end of the pump a ball of lighter density than the liquid rests on a seat and prevents further discharge of liquid and the passage of air out of the pump. Also shown are various pump control arrangements that can be used to operate the pump.

### BACKGROUND—PRIOR ART

Pneumatically powered submersible pumps have been in use in many industries for many years for moving liquids from below ground or tanks to storage, treatment and/or disposal. Such pumps have the ability to move solids and operate in difficult environments where electric pumps may have problems. These types of canister pumps have been and are used to move sewage from collection points, or lift stations, to the sewage treatment plants. They have also been used for underground environmental remediation where electricity was not desired or available or the environment required special materials that were not easily incorporated into electric pumps. Such canister pump construction is fairly simple and their operation easy to understand. Such pumps can be operated and serviced with a minimal amount of training. Very few moving parts are in the pump, so they can be very reliable and easy to operate and service. Compressed air is often preferred over electricity as the motive force for pumping such liquids when the liquid being pumped is flammable or the area in which the pump must operate, such as on an oil refinery, is susceptible to fire. The fill and discharge cycles of such pumps are usually controlled using preset timer controls.

Both pneumatic and electric timers have been used to operate such pumps. One of the problems with timer-controlled submersible canister pumps is that compressed air can be pushed out of the pumps along with the fluid being pumped if the pressurization cycle is too long. Previously the construction of submersible pneumatically-driven canister pumps has been such that it permits this to happen due to poor timer settings.

Many factors can negatively influence timer settings which can result in discharging compressed air with the liquid being pumped, including water in the compressed air line, a changes in air pressure, changes in submersion of the pump due to ground water fluctuations, and changes in back pressure in the discharge line. These and other factors can cause the once-proper and safe settings to become improper and potentially dangerous. When compressed air exits a canister pump with the liquid being pumped, oxygen can mix with suspended and dissolved constituents in the liquid forming deposits in discharge lines. If the liquid is flammable an explosive atmosphere can result. If the liquid contains hydrocarbons, hydrocarbons can be emitted into the atmosphere, contributing to air pollution.

The following is a tabulation of some prior art that presently appears relevant to this field and that of the present developments:

| Patent Number | Kind Code | Issue Date | Patentee |
|---|---|---|---|
| 122,950 | A | 1872 Jan. 23 | Lytle |
| 1,092,382 | A | 1914 Apr. 7 | Ness |
| 1,615,514 | A2 | 1927 Jan. 25 | Latta |
| 3,764,235 | A | 1973 Oct. 9 | Bittermann |
| 4,000,989 | A | 1977 Jan. 4 | Dunegan |
| 4,527,633 | A | 1985 Jul. 9 | McLaughlin |
| 5,004,405 | A | 1991 Apr. 2 | Breslin |
| 5,358,009 | A | 1994 Oct. 25 | Campbell |
| 5,358,073 | A | 1994 Oct. 25 | Edwards, et al |
| 5,470,206 | A | 1995 Nov. 28 | Breslin |
| 5,487,647 | A | 1996 Jan. 30 | Breslin |
| 5,868,280 | A | 1999 Feb. 9 | Schroeder |
| 5,944,490 | A | 1999 Aug. 31 | Breslin |
| 6,027,314 | A | 2000 Feb. 22 | Breslin |
| 6,039,546 | A | 2000 Mar. 21 | Edwards, et al. |
| 6,095,759 | A | 2000 Aug. 1 | Breslin |
| 6,220,823 | B1 | 2001 Apr. 24 | Newcomer |
| 6,234,761 | B1 | 2001 May 22 | Kocsis, et al |
| 7,316,544 | B2 | 2008 Jan. 8 | Vidrine |

| Patent Application | Country | Appl Date | Inventor/Assignee |
|---|---|---|---|
| JP56084158 | Japan | 1981 May 29 | Itaya/Mitsubishi |
| CN201520078175 | China | 2015 Feb. 4 | Pan, et al |

There have been a myriad of submersible pneumatically powered ejector or canister pump designs created for different industries for the purpose of moving liquids; see the Lytle and McLaughlin patents. Generally they all have an inlet check valve, a discharge check valve, a discharge pipe, an outer casing, a way of introducing a pressurized gas to push liquid out of the pump, and a way to exhaust pressurized gas from the pump. The expulsion of compressed air with the fluid being pumped can cause the problems noted at the end of the previous paragraph.

Previous designers have added external additions to such pumps that were designed to remove air in the fluid discharge. They include air removal devices, such as those manufactured by Val-Matic Valve & Manufacturing Co. of Elmhurst, IL. These, however, remove the air after it leaves the pump. Sometimes this is too late to prevent some of the negative effects of mixing air with the liquid. Often there is no room for these on environmental remediation sites or the pipelines are buried. In addition, the piping and valve costs can be expensive, especially on an oil refinery.

Submersible pneumatic pumps have been made with valves for allowing water to flow out of the bottom of the pump and remove what is above the water; see Edwards '546. They were not designed to prevent air from being pushed out of the pump discharge with liquid, nor do they do so.

Submersible pneumatic pumps have been made with float-actuated controls; see Ness '382, Breslin '405, and Breslin '494. These designs often necessitate rather large floats that require nearly the entire inside annular space of the pump. This is especially true with pumps being used to pump from wells where space is very limited. Such floats can be fouled by debris getting into the pump and thereby jamming the float or the air valves these floats operate. If material builds up on the pump wall or the float, the pump may not operate. The other moving parts in the pump can also be fouled. Aggressive liquids can attack the float and valve materials. Deposition of materials from the water, such as iron deposits, can jam the pump and necessitate frequent cleaning. Compressed air can facilitate the deposition of such material due to the oxygen compressed air introduces into the pump.

Casing-activated pumps (see Breslin '617, Breslin '314) have been designed to circumvent the need for an internal float to actuate pump air valves. Those casing-activated pumps with sliding seals for the casing can be fouled by deposits. Those with bellow seals have been found to need to operate within a relatively narrow pneumatic pressure range.

Pan '175 shows a design for a large air/water separation tank that is filled via an external well pump. Pan's design requires a vacuum pump on top of the tank to remove air from the tank and a third pump inside the tank to move the fluid from inside the tank. Also it requires three pumps to move water from a well. This system is designed to function outside of a well and so requires more equipment than is necessary for removing fluid from a well without air in the fluid.

Itaya shows a design for a large air/water separation tank. Itaya's tank is filled via an external pump. There is a floating ball in the discharge piping that prevents air from exiting with the water. Itaya shows an air outlet at the top of the tank. The pressure on the fluid leaving the tank is limited and determined by the height of the water inside the tank and/or imposed back pressure on the air exhaust. If the fluid discharge backpressure is less than the imposed back pressure placed on the tank air exhaust, it is possible for air to remain in the tank and the floating ball to seat, closing off fluid discharge. Unless the buoyancy force of the ball has been designed to overcome all possible resulting internal tank pressures, flow will not restart automatically. Such designs necessitate a relatively large ball compared to a relatively small opening in the seat, which would restrict flow. This would generally cause the design to be unsuitable for well pumping. If no back pressure is on the air exhaust, the fluid discharge pressure is limited by the height of fluid in the tank. An increase in fluid discharge back pressure could cause the tank to overflow through the air exhaust. These are both serious drawbacks to the system if it operates without surveillance. Moreover the system is employed outside of a well and so requires more equipment than is necessary for removing fluid from a well without air in the fluid. For the purpose of this disclosure the above patents are incorporated by reference as if fully set forth herein.

### SUMMARY

In accordance with one embodiment a submersible canister pump has a bottom-mounted inlet with a check valve for allowing liquid in, but not back out and a top-mounted outlet with a check valve for allowing liquid out, but not back in. The discharge pipe for the canister pump has a pipe tee at its base inside the pump. One end of the cross portion of the tee is attached to the bottom of the discharge pipe. The other end of the cross of the tee is attached to the inlet check valve. The 90° branch of the tee has an L-shaped fitting attached. The horizontal end of the L-shaped fitting is attached to the pipe tee on the bottom of the discharge pipe, while the vertical end faces upward with a cage, ball and seat on its open end. The ball has a lower specific gravity than water or any other liquid expected to enter the pump so that it floats on the liquid. The ball is captive in the cage above the seat so it will reseat when the fluid level in the canister falls to the level of the floating ball seat. The cage has almost all of its perforations near the base and a protective area for the ball in its upper area where the ball can float without being pulled down to the seat by discharging water. One or more small perforations can be provided near the top of the cage for allowing air to escape from the protected area. The protected area can be eliminated if the screened inlet to the air exclusion valve were extended upward in the pump sufficiently away from the seat so the floating ball would not be entrained by discharging liquid and be pulled onto the seat until the water level nears the seat. When fluid in the canister is falls near the floating ball seat, the floating ball closes off the discharge of fluid and air and thus no air can be pushed out of the pump with fluid.

### ADVANTAGES

From the description above, a number of advantages of one or more embodiments of my air exclusion valve for submersible pneumatic pumps become evident:
(a) The air exclusion valve in combination with piping for allowing liquid flow to and/or from a discharge pipe in a pneumatic canister pump prevents compressed air and/or other gases that have entered the pump from being pushed up the discharge tube with the liquid in the pump, thus reducing turbulence in the liquid being discharged.
(b) The above arrangement also prevents compressed air and/or other gases that have entered the pump from being pushed up the discharge tube with the liquid in the pump thus reducing oxygen contact with the liquid being pumped which may cause adverse chemical reactions
(c) The arrangement also prevents compressed air and/or other gases that have entered the pump from being pushed up the discharge tube with the liquid in the pump thus reducing the chance that oxygen may mix with fumes from the liquids being pumped and other gases in the well which could result in a flammable or explosive mixture being created or hydrocarbons being released to the atmosphere.
(d) The air exclusion valve arrangement in a submersible, pneumatically driven canister pump can be used in combination with timers to eliminate air being discharged with the fluid being pumped. That allows existing timer systems to be used with the improved pump design.
(e) Further, it allows the controls to use only one timer instead of the two that are normally used, thus reducing costs since pneumatic timers can be much more expensive than typical air valves.
(f) It further allows the controls to use only one pneumatic timer instead of the two that are normally used, thus reducing possible problems because pneumatic timers are more prone to failure than most pneumatic air valves.
(g) It additionally makes the setting of the controls by a technician much simpler, since there is no need to be careful setting a timers that govern the pressurization and exhaust cycles of the pump.

Further advantages of one or more aspects will become apparent from a consideration of the ensuing description and accompanying drawings.

DRAWINGS

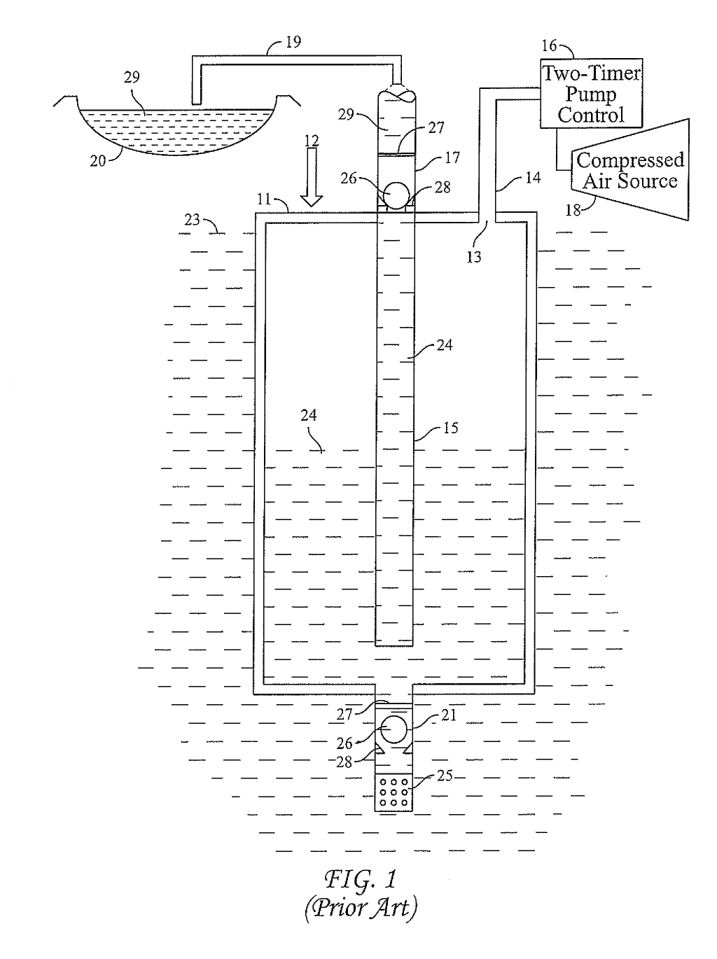

FIG. 1 shows prior art schematic view of a typical bottom-loading prior-art submersible pneumatic canister pump with a two-timer pump control currently in use in many industries.

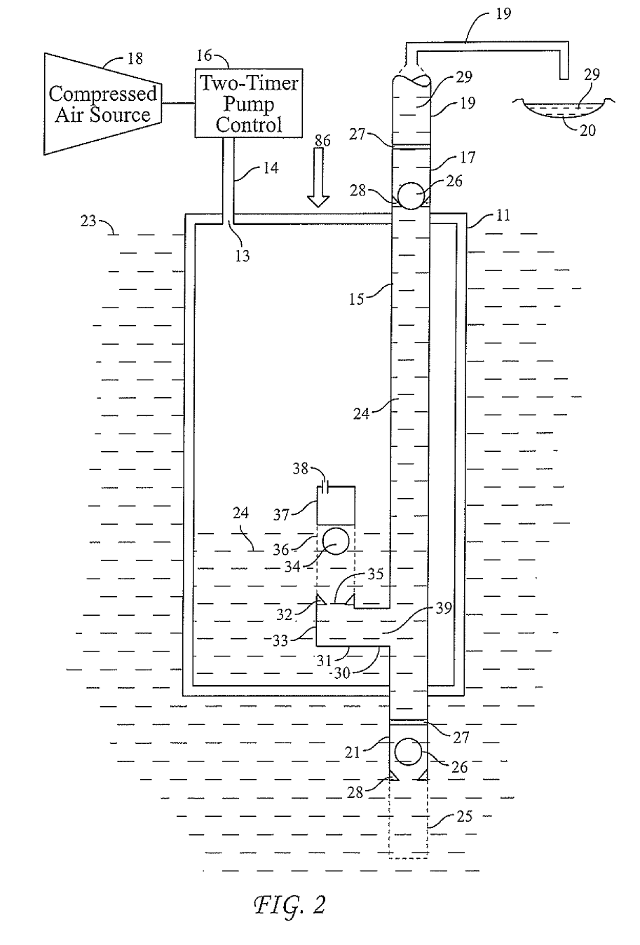

FIG. 2 shows a schematic view of a bottom-loading submersible pneumatic canister pump with a two-timer pump control currently in use in many industries with the addition of an air exclusion valve connected to the pump discharge pipe via a tee and 90-degree elbow fitting near the bottom of the pump.

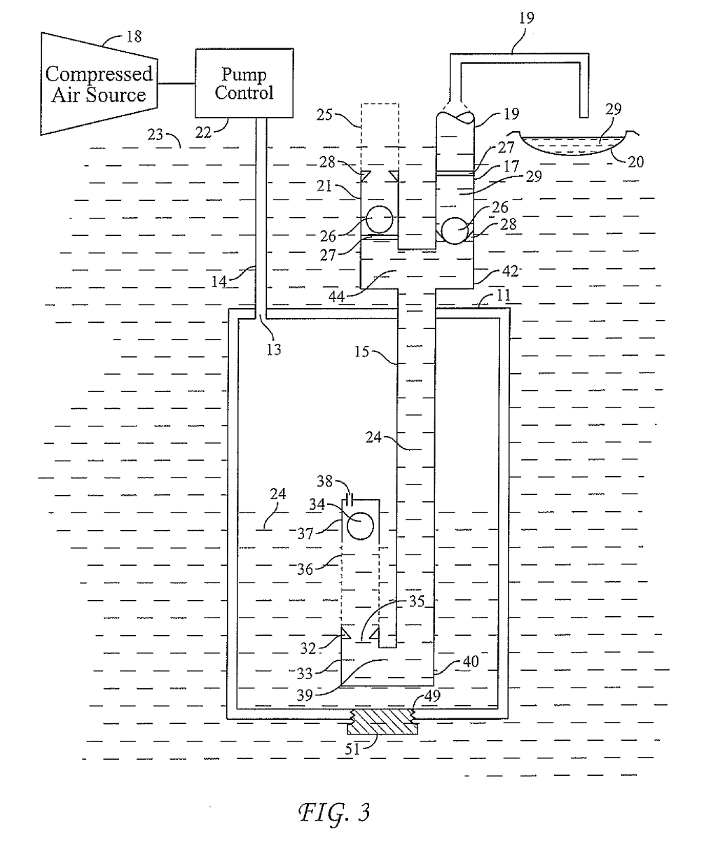

FIG. 3 shows a schematic view of a top-loading submersible pneumatic canister pump with a generic pump control with a Y-shaped fitting at the top of the pump holding the inlet and discharge check valves and with an air exclusion valve connected via a U-shaped fitting on the bottom of the discharge pipe.

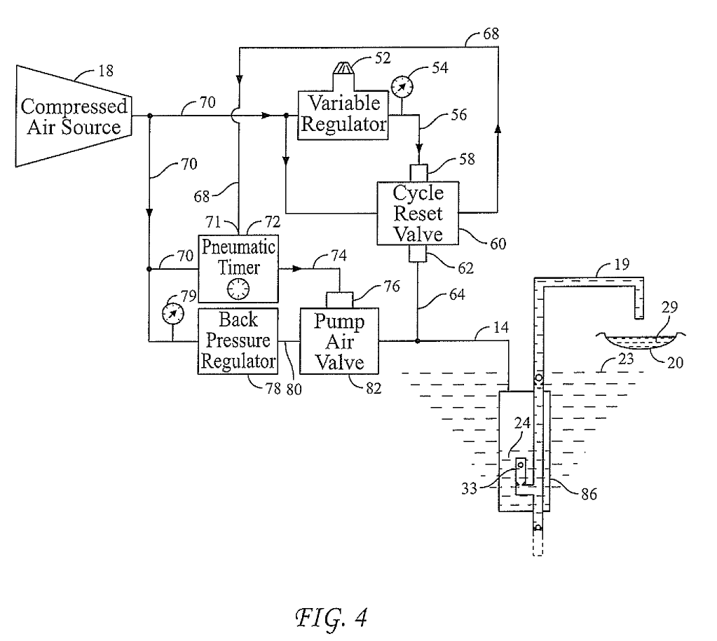

FIG. 4 shows a pneumatic schematic of a control system with only one timer that can be used to operate a submerged submersible pneumatic canister pump containing an air exclusion valve.

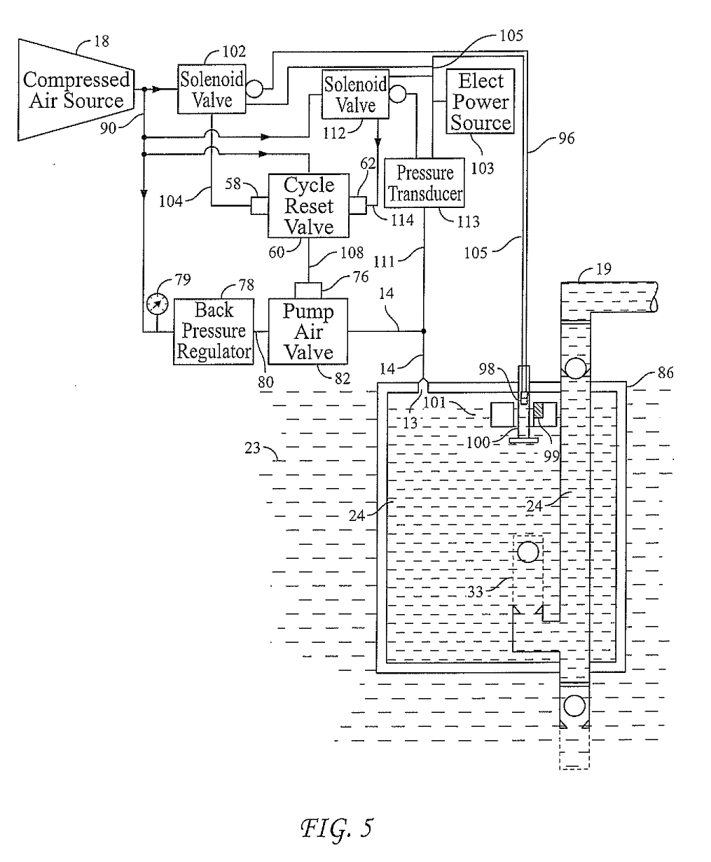

FIG. 5 shows a schematic of an electric/pneumatic control and a submersible pneumatic canister pump with an electric float switch and an air exclusion valve.

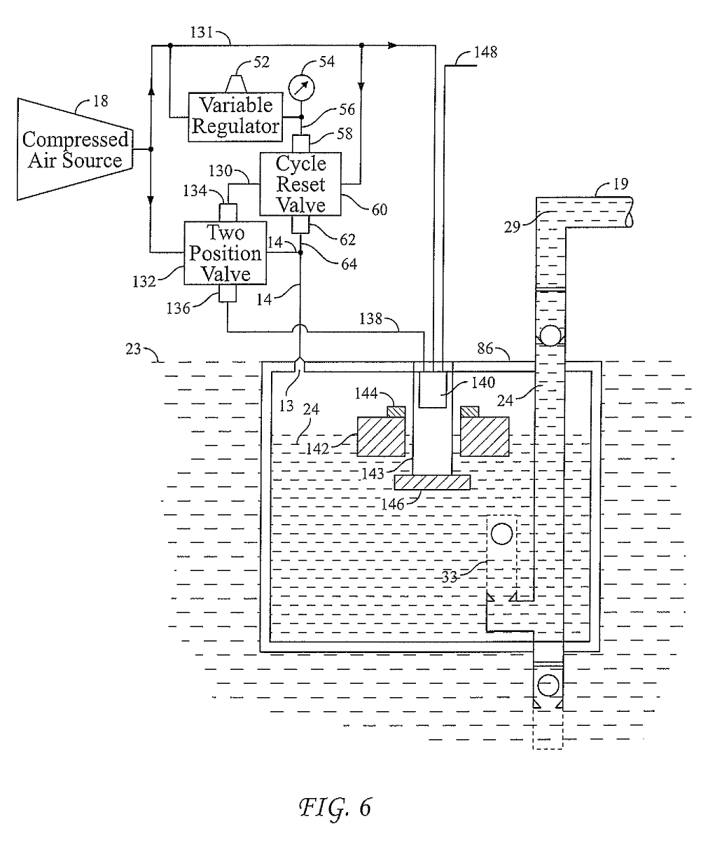

FIG. 6 shows a schematic of a pneumatic control and a submersible pneumatic canister pump with a pneumatic float switch and an air exclusion valve.

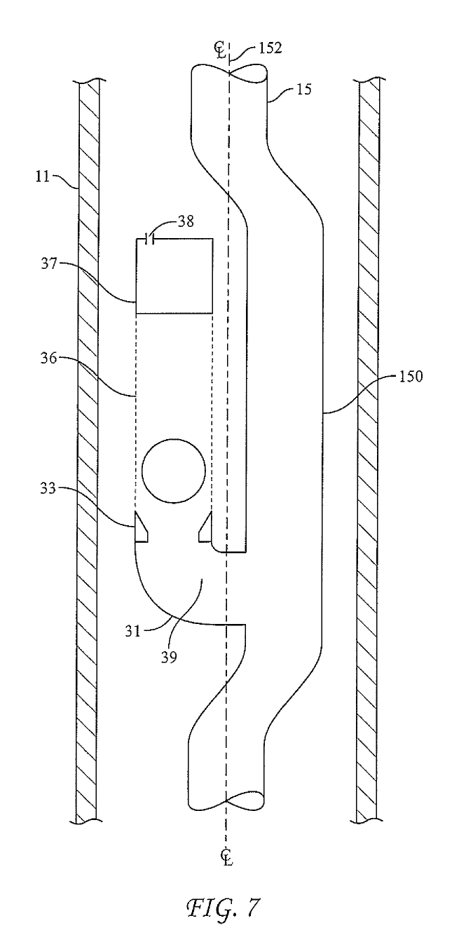

FIG. 7 shows an offset section of the discharge pipe in the area of the air exclusion valve for allowing the discharge pipe to be centered in the pump casing.

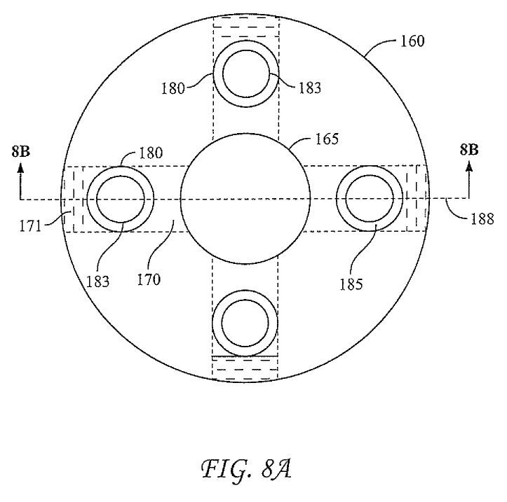

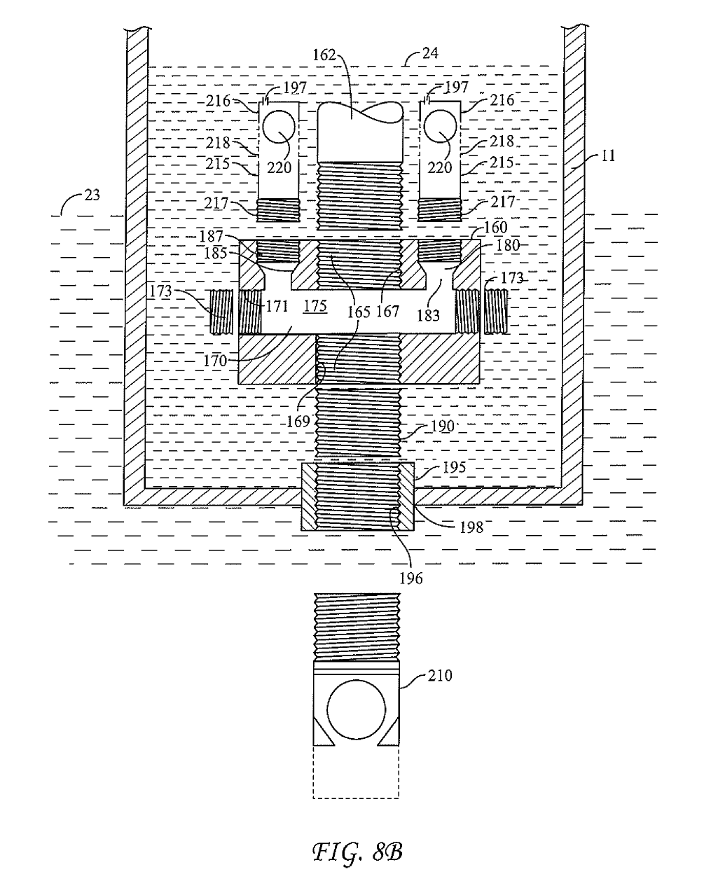

FIGS. 8A and 8B show air exclusion valves configured radially for allowing the discharge pipe to be centered in the pump casing.

Drawings--Reference Numerals

| | | | |
|---|---|---|---|
| 11 | Pump casing | 12 | Prior art pneumatic submersible canister pump |
| 13 | Opening: comp. air enter & exh. exit | 14 | Air hose |
| 15 | Discharge pipe | 16 | Two-timer pump control |
| 17 | Discharge check valve | 18 | Compressed air source |
| 19 | Liquid discharge hose | 20 | Liquid holding pond |
| 21 | Inlet check valve | 22 | Pump control |
| 23 | Exterior liquid | 24 | Interior liquid |
| 25 | Inlet check valve screen | 26 | Check valve ball |
| 27 | Crossbar | 28 | Check valve ball seat |
| 29 | Discharged liquid | 30 | Tee |
| 31 | 90° elbow | 32 | Floating ball seat |
| 33 | Air exclusion valve | 34 | Floating ball |
| 35 | Opening in air exclusion valve seat | 36 | Screened floating ball cage |
| 37 | Protective cap | 38 | Air opening in protective cap |
| 39 | Fluid Passage | 40 | U-shaped fitting |
| 42 | Y-shaped fitting | 44 | Y-fitting passage |
| 49 | Threaded opening in bottom of pump casing | | |
| 51 | Threaded plug | 52 | Variable air regulator |
| 54 | Gauge | 56 | Regulated air line |
| 58 | Biasing actuator | 60 | Cycle reset valve |
| 62 | Cycle reset actuator | 64 | Air line |
| 68 | Timer reset air line | 70 | Compressed air supply line |
| 71 | Timer actuator port | 72 | Pneumatic timer |
| 74 | Pneumatic timer output air line | 76 | Pump air valve actuator |
| 78 | Back pressure regulator | 79 | Gauge |
| 80 | Pump valve air supply line | 82 | Pump air valve |
| 86 | Pneumatic canister pump with air exclusion valve | 90 | Air line |
| 96 | Electrical cable | 98 | Electric proximity switch |
| 99 | Magnet | 100 | Float guide |
| 101 | Float | 102 | Solenoid valve |
| 106 | Low voltage power source | 104 | Air line |
| 105 | Electric wires | 108 | Air line |
| 111 | Pressure transducer air line | 112 | Solenoid valve |
| 113 | Pressure transducer | 114 | Airline |
| 130 | Air line | 131 | Airline |
| 132 | 2-position 3-way pump air valve | 134 | Exhaust mode actuator |
| 136 | Pressure mode actuator | 138 | Airline |
| 140 | Pneumatic proximity switch | 142 | Float |
| 143 | Float Guide | 144 | Magnet |
| 146 | Float stop | 148 | Pneumatic proximity switch exhaust air line |
| 150 | Offset section of discharge pipe | 152 | Casing centerline |
| 160 | Air exclusion valve manifold block | 162 | Threaded discharge pipe |
| 165 | Center bore | 167 | Threads |
| 169 | Threads | 170 | Radial cross bore |
| 171 | Threads | 173 | Threaded plug |
| 175 | Internal liquid passage | 180 | Large vertical bore |
| 183 | Small vertical bore | 185 | Ball seat |
| 187 | Threads | 188 | Section line |
| 190 | Threaded nipple | 195 | Threaded coupling |
| 196 | Threads | 197 | Air opening |
| 198 | Casing penetration | 210 | Threaded inlet check valve |
| 215 | Threaded ball cage | 216 | Protective cap |
| 217 | Threads | 218 | Screen |
| 220 | Floating ball | | |

### DETAILED DESCRIPTION

FIG. 1—Prior Art—Bottom-Loading Submersible Pneumatic Canister Pump

FIG. 1 shows a typical prior-art pneumatic submersible canister pump currently used in many industries; prior art pneumatic submersible canister pump 12 is submerged in exterior liquid 23 to be pumped. It consists of a sealed pump casing 11 with an upper and lower end, an interior and exterior and opening 13 for compressed air to enter and exhaust air to exit casing 11. An inlet check valve 21 allows exterior liquid 23 to enter casing 11, but does not allow interior liquid to be discharged 24 to exit. A discharge check valve 17 allows interior liquid 24 to exit casing 11, but does not allow discharged liquid 29 to enter. A discharge pipe 15 extends from near the bottom of casing 11 up through the top of casing 11 with discharge check valve 17 attached at the upper end. Liquid discharge hose 19 carries discharged liquid 29 from pump casing 11 to a discharge point, such as a liquid holding pond 20. A two-timer pump control 16, supplied with compressed air from compressed air source 18, alternately pressurizes and exhausts the interior of pump casing 11.

Such a pump is typically operated using two timers. One timer controls the time to exhaust pressurized air from the interior of pump casing 11 to allow pump casing 11 to fill with interior liquid 24, while the other timer controls the time to pressurize the interior of casing 11 and force interior liquid 24 from inside casing 11. A fill time setting may be from 3 to 30 seconds or even longer. The discharge time is usually in the same range. A person skilled in pump design is able to initially select the most appropriate settings, depending upon the back pressure in liquid discharge hose 19, pump submergence, fluid flow, air pressure, the size of the pump, and other factors. These factors can vary site to site and even well to well and they can change over time. The operating pressure for pumps on landfill sites, for example, typically ranges between 40 and 100 psi. However, the operating pressures can be higher for sites with deep water tables and/or high back pressure in liquid discharge line& 19. Clean Environment Equipment of Oakland, Calif. designed pneumatically-driven down-well pumps to operate at over 150 psi.

When two-timer pump control 16 is in its exhaust cycle and the interior of casing 11 has a lower pressure than the hydrostatic pressure applied by exterior liquid 23 at inlet check valve 21, exterior liquid 23 enters casing 11 through check valve 21. Exterior liquid 23 passes into an inlet check valve screen 25 by lifting check valve ball 26 from inlet check valve ball seat 28. Check valve ball 26 is prevented from traveling into pump casing 11 by a crossbar 27. Air inside casing 11 is displaced through opening 13 in casing 11 and up air hose 14. For clarification in this disclosure exterior fluid 23 becomes interior liquid 24 upon exiting inlet check valve 21 and interior liquid 24 becomes discharged liquid 29 upon exiting outlet check valve 17. When casing 11 is filled with interior liquid 24, two-timer pump control 16 eventually switches to its pressurization cycle and allows pressurized air, supplied by compressed air source 18, to flow through air hose 14 and enter casing 11 through opening 13

When the pressure in casing 11 exceeds the hydrostatic pressure of exterior liquid 23 and the back pressure in discharge hose 19, interior liquid 24 in casing 11 moves check valve ball 26 onto check valve ball seat 28 in inlet check valve 21 to prevent interior liquid 24 from exiting. Interior liquid 24 is forced up through discharge pipe 15, through discharge check valve 17 by lifting check valve ball 26 from seat 28 and into discharge hose 19, where it becomes discharged liquid 29.

Eventually pump control 16 exhausts the pressurized air from casing 11, allowing exterior liquid 23 to again enter inlet check valve 21.

By repeating the exhaust and pressurization cycles, exterior liquid 23 is moved to another location, such as holding pond 20. Discharge check valve 17 operates as inlet check valve 21 for allowing liquid flow to move in one direction only. Crossbar 27 prevents ball 26 from traveling into discharge hose 19 and discharged liquid 29 is prevented from passing through discharge check valve 17 and entering pump casing 11 by ball 26, which rests on seat 28.

This prior-art design can allow compressed air to exit pump casing 11 via discharge pipe 15 if pump control 16 continually supplies compressed air into casing 11 after the level of interior liquid 24 has fallen to the lower end of discharge pipe 15. However carefully timers are set when a pump is installed, changes in discharge hose back pressure, submergence, compressed air purity, and liquid viscosity can result in such timer settings being too long or too short.

Pneumatic timers are especially susceptible to failure and timing changes due to their dependence on the purity of compressed air and temperature. Pushing compressed air out of discharge pipe 15 with interior liquid 24 mixes oxygen with discharged liquid 29 and that can cause deposition of suspended and dissolved solids. It can also cause fume-laden compressed air to exhaust into the atmosphere at holding pond 20. Further, it can cause turbulence in discharged liquid 29 in discharge hose 19 and at holding pond 20, which may cause adverse chemical reactions and unwanted solid suspension in discharged liquid 29.

FIG. 2—Bottom-Loading Submersible Pneumatic Pump with Air Exclusion Valve

FIG. 2 shows pneumatic canister pump with air exclusion valve 86 in a bottom-loading configuration according to a first embodiment. Pump 86 is submerged in exterior liquid 23 for the purpose of pumping such liquid out of its holding vessel (not shown), such as a well. Pump 86 has an air exclusion valve 33 and a fluid passage 39 for allowing interior liquid 24 to travel between discharge pipe 15 and air exclusion valve 33. Air exclusion valve 33 consists of a floating ball 34 that has a density less than interior liquid 24; a floating ball seat 32; a screened floating ball cage 36; a protective cap 37 with air opening in protective cap 38. Air exclusion valve 33 is in fluid connection with discharge pipe 15 via a 90° elbow 31 and a tee 30. The other opening of tee 30 is attached to inlet check valve 21. Two-timer pump control 16 and compressed air source 18 are the same as in FIG. 1.

Pump 12 operates as follows: When the interior of pump casing 11 has a lower pressure than the hydrostatic pressure applied by exterior liquid 23 at inlet check valve 21, exterior liquid 23 enters pump casing 11 first through screened inlet 25 and then through inlet check valve 21. Check valve ball 26 lifts off seat 28 allowing flow into pump casing 11. Crossbar 27 prevents check valve ball 26 from traveling into pump casing 11. Interior liquid 24 travels through tee 30, fluid passage 39, and elbow 31 and flows up through opening in air exclusion valve ball seat 35. Interior liquid 24 carries floating ball 34 up into screened cage 36 and into protective cap 37, where it is shielded from liquid drag forces when interior liquid 24 is forced from the interior of casing 11. Cap 24 has a small air opening 38 for allowing air to escape. Interior liquid 24 flows out of screened cage 36 into casing 11. As interior liquid 24 rises in pump casing 11, the air inside pump casing 11 is exhausted through opening 13 and into air hose 14.

When pump casing 11 is filled with interior liquid 24, control 16 allows pressurized air supplied by compressed air source 18 to flow through air hose 14 and enter pump casing 11 through opening 13. Thus opening 13 constitutes an air passage means for allowing compressed air into pump casing 11 to pressurize the internal volume of pump casing 11. When the pressure in pump casing 11 exceeds the hydrostatic pressure of exterior liquid 23, ball 26 is forced onto seat 28, preventing interior liquid 24 from exiting through inlet check valve 21. Thus check valve 21 is a check valve means for allowing exterior liquid 23 into pump casing 11, but not allowing interior liquid 24 out. When the air pressure in pump casing 11 exceeds the back pressure in discharge hose 19, interior liquid 24 in casing 11 is forced through screened ball cage 36, down through opening in air exclusion valve seat 35, through elbow 31, through fluid passage 39 and tee 30, into discharge pipe 15, and up and out of casing 11 through discharge check valve 17, and into discharge hose 19.

Discharge check valve 17 acts like inlet check valve 21 to allow flow in only one direction in that ball 26 rises off seat 28 when interior liquid 24 flows in the direction from seat 28 to crossbar 27 and prevents discharged liquid 29 from flowing into casing 11 due to ball 26 resting on seat 28. Thus check valve 17 is a check valve means for allowing interior liquid 24 out of pump casing 11 and preventing discharged liquid from flowing into casing 11. As the level of interior liquid 24 falls in pump casing 11 to the level of ball seat 32, floating ball 34 leaves protective cap 34 and floats downward and eventually rests on ball seat 32, preventing interior liquid 24 and any compressed air from entering discharge pipe 15. Thus air exclusion valve 33 comprises an air exclusion means that prevents air from exiting pump 86 and mixing with discharged liquid 29. Since ball 34 resting on seat 32 prevents interior liquid 24 and compressed air from leaving casing 11, the air pressure in casing 11 increases toward that being delivered by compressed air source 18 unless compressed air is exhausted immediately. This increase in pressure is of little consequence in this embodiment, but will be shown to be of great use in subsequent drawing descriptions.

Eventually control 16 exhausts the compressed air from pump casing 11 out of opening 13 and casing 11 can again fill. Thus opening 13 constitutes an air passage means for allowing compressed air out of pump casing 11 to depressurize the internal volume of pump casing 11. By repeating the exhaust and pressurization cycles, exterior liquid 23 is moved to another location such as holding pond 20. Thus two-timer control 16 is a control means to pressurize and exhaust the interior of casing 11.

Thus compressed air cannot leave casing 11 and mix with discharged liquid 29. This is has many advantages over the prior art, including:
Turbulence in discharge hose 19 is reduced so that suspended solids in discharged liquid 29 are not agitated into a more secure suspension.
Immiscible liquids, such as oil and water, are not churned together to form a suspension or dissolve the constituents of one into the other.
Oxygen interaction with discharged liquid 29 is reduced so the formations of depositions from the oxygenation of dissolved and suspended minerals, such as iron, in discharged liquid 29 is reduced. Such depositions can clog discharge pipe 15, foul discharge check valve 17, and clog discharge hose 19. If discharged liquid 29 contains volatile hydrocarbons, the introduction of oxygen may create a flammable environment.
Gas releases at holding pond 20 are reduced, so that release of hydrocarbons into the atmosphere is lessened.
Compressed air, energy and air compressor capacity are conserved by not discharging compressed air into discharged liquid 29.

Other piping and machined part arrangements are capable of the same performance to one familiar with the piping and liquid flow arts.

FIG. 3—Top-Loading Submersible Pneumatic Canister Pump with Air Exclusion Valve

FIG. 3 shows my submersible pneumatic pump in a top-loading embodiment submerged in liquid 23. This embodiment is similar to that of FIG. 2, except that inlet check valve 21 and discharge check valve 17 are both located in a Y-shaped fitting 42 attached to the top of discharge pipe 15.

The bottom of pump casing 11 is sealed. Fitting 42 has a passage 44 below both inlet check valve 21 and discharge check valve 17. Passage 44 allows interior liquid 24 to pass downward from inlet check valve 21 into discharge pipe 15 during the exhaust cycle of casing 11 and upward from discharge pipe 15 and out of discharge check valve 17 during the pressurization cycle of the interior of casing 11. Discharge pipe 15 is fluidly connected with air exclusion valve 33 via a U-shaped fitting 40. Pump control 22 is shown as generic as it can be a two-timer control or one such as shown in FIG. 4.

When the level of exterior liquid 23 is above the inlet to check valve 21 and the interior of casing 11 has a lower pressure than the pressure applied by exterior liquid 23 at valve 21, exterior liquid 23 enters casing 11 first through screened inlet 25 and then through inlet check valve 21. Ball 26 is moved from seat first through screened inlet 25 and then through inlet check valve 21. Ball 26 is moved from seat 28 by the flow of exterior liquid 23. Ball 26 is prevented from traveling into casing 11 by crossbar 27. Interior liquid 24 then flows down through pipe 15 and up through valve 33 that is attached to the lower end of pipe 15 via U-shaped fitting 40. Air inside casing 11 is exhausted through opening 13 and into air hose 14. As interior liquid 24 passes through valve 33 through opening 35, ball 34 lifts from seat 32. Ball 34 is of lower density than interior liquid 24 so it floats on interior liquid 24. As the level of interior liquid 24 rises inside casing 11, ball 34 is carried upward into screened cage 36 to protective cap 38 that has a small opening 38 for allowing air to escape.

During the discharge cycle pump control 22 causes pressurized air supplied by compressed air source 18 to flow through air hose 14 and enter casing 11 through opening 13. When the pressure in casing 11 exceeds the pressure of exterior liquid 23 and back pressure in discharge hose 19, interior liquid 24 is forced back through opening 35, through U-shaped fitting 40, and up pipe 15. Ball 26 is carried onto seat 28, preventing interior liquid 24 from exiting valve 21. Interior liquid 24 in casing 11 is forced up and out of casing 11 through valve 17 and into hose 19. As the level of interior liquid 24 falls to the level of seat 32, ball 34 travels downward and eventually rests on seat 32, preventing interior liquid 24 and any compressed air from entering pipe 15. Due to the sealing of casing 11 by ball 34 on seat 32, the air pressure in casing 11 continues to increase toward that of the compressed air supplied by pump control 22. Eventually pump control 22 exhausts compressed air from hose 14 and subsequently out of opening 13. Casing 11 can then again fill. By repeating the exhaust and pressurization cycles, exterior liquid 23 is moved to another location, such as holding pond 20.

The bottom of casing 11 is shown having a threaded opening 49 with threaded plug 51 sealing threaded opening 49. Threaded plug 51 can be removed and the outlet end of another inlet check valve 21 can be threaded into opening 49 to create a bottom-and-top-loading pump configuration. If only a bottom-loading configuration is desired, inlet check valve 21 can be removed from fitting 42 and attached at opening 49, Y-shaped fitting 42 can be removed from pipe 15, and outlet check valve 17 can be attached to the top of pipe 15. Thus the design is versatile.

The advantages of this arrangement are the same as described in connection with FIG. 2 and are even more important. This is because the top-loading configuration using Y-shaped fitting 42 was designed and used for years by Clean Environment Equipment of Oakland, Calif. to capture lighter, immiscible liquids, such as gasoline and diesel oils, along with water upon which they float. Such lighter liquids can be flammable and contain harmful chemicals, such as benzene, that can dissolve in water. Also they are harmful when released into the atmosphere. Thus the reductions in turbulence, oxygen interaction, and escaping gases are especially important.

Other piping and machined part arrangements are capable of the same performance, as will be recognized by one familiar with the piping and liquid flow.

FIG. 4—Control Schematic For Submersible Pneumatic Canister Pump with Air Exclusion Valve

FIG. 4 shows a schematic of a circuit that comprises a control means to control the pumping from a submersible pneumatic canister pump 86 containing air exclusion valve 33. Pump 86 is submerged in exterior liquid 23. Pump 86 is constructed and operates the same as shown in FIG. 2.

The control means for controlling submersible canister pump with air exclusion valve 86 comprises compressed air source 18, regulator 52, cycle reset valve 60, pneumatic timer 72, spring return valve 82 and operable connected air lines 14, 56, 64, 68, 70, and 74.

The circuit includes compressed air source 18, variable air regulator 52 that provides a desired pressure that determines the start of the exhaust cycle, and cycle reset valve 60 which in this case is a two-position, three-way valve. Valve 60 has biasing actuator 58 that is pressurized by air from regulator 52, and cycle reset actuator 62 that is pressurized by pump air hose 14 through air line 64. Pressure gauge 54 reads the bias pressure applied to actuator 58. Pneumatic timer 72 is utilized in this design versus two timers such as used currently in the industry. Timer 72 is shown as pneumatic but can also be electric.

Pneumatic timer 72 delays pressurized air from passing to pump air valve actuator 76 until a desired time has expired. This allows time for canister pump 86 to fill. This time is typically adjustable from 1 to 30 seconds and is set based upon the particular parameters of the environment and pump use. For slow-flow operations, this time may be extended to many minutes. An electro-pneumatic timer can also be used for this purpose. Back pressure regulator 78 maintains a pressure in the circuitry that is above the minimum operating pressure of all components. The available pressure for control components can be read on gauge 79 with valve 82 open to atmosphere. Back pressure regulator 78 and gauge 79 are not necessary if the operation of pump 86 does not lower the air pressure below the minimum operating pressure of the pneumatic components. Gauge 54 is not required once variable regulator 52 is set or if the regulator used is not variable, but factory preset.

In this embodiment pump air valve 82 is a three-way, spring return valve and is positioned between pump valve air supply line 80 and pump air line 14. Valve 82 prevents compressed air from passing to pump air line 14 until actuator 76 is pressurized during the pressurization cycle phase of pumping. After the pressurization phase actuator 76 is depressurized valve 82 again prevents air from passing to pump air line 14 and simultaneously exhausts pump air line 14. Actuator 76 is pressurized by the output of timer 72 via pneumatic timer output air line 74.

Compressed air source 18 supplies air through compressed air supply line 70 to regulator 52, cycle reset valve 60, pneumatic timer 72, and back pressure regulator 78. Regulator 52 is set to a pressure that will allow discharged liquid 29 to be pumped to a desired destination, such as holding pond 20. Air line 56 conveys this pressure to actuator 58 that controls cycle reset valve 60. Cycle reset valve 60 passes compressed air through timer reset air line 68 to timer actuator port 71 until the air pressure at actuator 62, which is the pressure inside pneumatic canister pump with air exclusion valve 86, is greater than the air pressure pressurizing actuator 58.

The controls begin operation when air line 70 is pressurized by compressed air source 18. Regulator 52 supplies compressed air to actuator 58, which shifts valve 60 to pass air to timer actuator port 71. This initiates the preset exhaust cycle of timer 72. During the exhaust cycle period no compressed air passes out of timer 72 to actuator 76, so valve 82 remains in exhaust position, allowing compressed air to exhaust from pump 86 via air hose 14. This allows submerged pump 86 to fill.

When the preset exhaust cycle period of timer 72 ends, timer 72 passes air into pneumatic timer output air line 74, pressurizing actuator 76, which causes valve 82 to open and pass compressed air through air hose 14 to pump 86. This causes interior liquid 24 in pump 86 to be forced out of pump 86 and discharged into discharge hose 19. When the level of interior liquid 24 in pump 86 reaches air exclusion valve 33, valve 33 closes, preventing interior liquid 24 and compressed air from exiting pump 86, thereby causing the pressure in pump 86 and air hose 14 to rise (see FIGS. 2 and 3). Thus air exclusion valve 33 is a float-sealing means for preventing compressed air from being discharged with interior liquid 24 from pump 86.

The pressure in hose 14 is transmitted via air line 64 to cycle reset actuator 62 of valve 60. When the pressure in line 64 exceeds the biasing pressure applied to actuator 58 by regulator 52, valve 60 shifts to exhaust the compressed air in air line 68, thus removing pressurized air from timer actuator port 71. This causes timer 72 to exhaust air from line 74, causing valve 82 to close and exhaust air from air hose 14 and pump 86. This allows pump 86 to again fill. As pressure in line 14 decreases below that exiting regulator 52, cycle reset valve 60 shifts, allowing compressed air to pass again to timer actuator port 71. This air pressure then activates timer 72 to begin timing the exhaust cycle. Thus the pressurization and exhaust cycles are alternated automatically, moving exterior liquid 23 to holding pond 20. Hence such an arrangement of components comprises a pump control means to pressurize and exhaust pump 86.

Suitable Air controls and valves are available from Clippard Instrument Laboratory, Inc. of Cincinnati, Ohio, USA and Norgren Inc. of Littleton, Colo., USA. Pneumatic timers are available from Parker Hannifin Corporation of Cleveland, Ohio. Electric timers with solenoid valves are produced by Allenair Corporation of Mineola, N.Y.

This pneumatic control is an improvement over current canister pump controls in the following ways:
It uses only one timer, where normal canister pump controls need two. This reduces cost and maintenance.
The single timer used in the present embodiment controls only the exhaust cycle, not the pressure cycle. If the exhaust cycle is too long or too short, no problem is created, other than reduction in pump rate and some waste in compressed air. In a typical pump control for a canister pump both the exhaust and pressure cycles are controlled by timers. During the pressure cycle such a pump control will supply compressed air to the canister pump until the pressure timing cycle ends regardless if all fluid has been pushed from the canister pump. With such a pump controller compressed air can exit the pump along with the pumped fluid. The addition of an air exclusion valve and fluid passages as presented herein prevents this from occurring.
In this embodiment of pneumatic circuitry the pressurization cycle is ended and the exhaust cycle is automatically begun without the chance of compressed air exiting with the liquid being pumped. Typical canister pump controls rely on a timer setting to regulate the pressurization cycle. Variations in compressed air pressure, humidity and purity, ground water levels, and liquid back pressure can cause such settings to over or under pressurize the canister pump. When this happens compressed air can be introduced into the liquid stream and is wasted. The negative effects of this have been listed previously.
The use of two timers has caused some systems to fail to pump liquids, thus defeating the use of the pump. In such a case, even if an operator knows there is liquid above the pump, it is difficult to tell if the pump has failed due to inlet check valve backflow. Utilizing this design an operator can tell without a gauge within one pressure cycle if the inlet check valve is operating properly and being pressurized sufficiently to move liquid to the desired location by listening to the force of the compressed air exhausting the control. Compressed air should exhaust with the same force as it did in the initial installation.

Other pneumatic, electro-pneumatic and electric component arrangements are capable of the same pressurization and exhaust cycling of a pump and are easily designed by those familiar with pneumatic circuitry.

FIG. 5—Electric/Pneumatic Control Schematic for Submersible Pneumatic Canister Pump with Air Exclusion Valve and Float Switch

FIG. 5 shows an electro-pneumatic system that can be used to control the pumping from a submersible pneumatically-driven canister pump with air exclusion valve 86. Pump 86 is submerged in exterior liquid 23. Pump 86 is similar to the pump in FIG. 2. In addition, it has a float 101 with an internal magnet 99 that rides on a float guide 100 mounted near the upper end of the interior of pump 86. Pump guide 100 contains an electric proximity switch 98 that operates when float 101 approaches the top of float guide 100. Thus magnet 99 constitutes a switch means that that causes electric proximity switch 98 to operate when float 101 is in proximity with electric proximity switch 98. Float 101 with magnet 99, guide 100, and electric proximity switch 98 are shown internal to pump 86. These components can alternatively be located externally of pump 86.

The control system for pump 86 includes a low-voltage power source 103 and electric wires 105 that provides power to a pressure transducer 113, float switch 98, and electro-pneumatic three-way solenoid valves 102 and 112. Also included is compressed air source 18, a gauge 79 and a back pressure valve 78, pump air valve 82 with actuator 76, cycle reset valve 60 with actuators 62 and 58, and air lines 14, 80, 90, 104, 108, 111, and 114 .

Before compressed air source 18 is connected to air line 90, pump air valve 82, which in this embodiment is a three-way, spring-return valve, is positioned via spring bias to exhaust compressed air from air hose 14. This allows exterior liquid 23 to enter pump 86. When pump 86 is nearly full, float 101 rises on float guide 100 bringing magnet 99 in proximity to electric proximity switch 98 inside float guide 100, causing electric proximity switch 98 to operate. The operation of electric proximity switch 98 causes solenoid valve 102 to open and connect air line 90 to air line 104. After compressed air source 18 is connected to air line 90, air passes through solenoid valve 102 and through air line 104 to pressure actuator 58. Actuator 58 shifts cycle reset valve 60, which in this embodiment is a two-position, three-way valve, to pass pressurized air through air line 108 to pump air valve actuator 76, causing pump air valve 82 to open. Pump air valve 82 passes pressurized air through hose 14 to pump 86, forcing interior liquid 24 out of pump 86 and into discharge hose 19.

As the level of interior liquid 24 falls in pump 86, float 101 falls to the bottom of float guide 100, returning proximity switch 98 inside float guide 100 to its original position. This causes valve 102 to close and exhaust the pressurized air in air line 104. This relieves pressure from actuator 58. Valve 60 remains in its shifted position until actuator 62 is pressurized. When the level of interior liquid 24 in pump 86 reaches air exclusion valve 33, valve 33 closes to prevent air and interior liquid 24 from leaving pump 86, causing pressure in pump 86 and air hose 14 to rise. The pressure in air hose 14 is transmitted via air line 111 to transducer 113.

When sufficient pressure exists in air line 111, transducer 113 sends a signal to open solenoid valve 112, which passes compressed air to exhaust cycle actuator 62, causing cycle reset valve 60 to shift, exhausting pressurized air from line 108 and actuator 76. This closes pump air valve 82 and exhausts compressed air from air hose 14. This depressurizes pump 86, allowing exterior liquid 23 to again enter to begin the pumping cycle again. Thus the combination of pressure transducer 113, solenoid valve 112, cycle reset valve 60 and actuator 62 constitute a preset pressure sensing means causing said compressed air to be exhausted from said sealed casing allowing exterior liquid 23 to be pumped to again enter pump 86.

Electric pressure transducers and electro-pneumatic valves are available through Omega Engineering Inc. of Stamford, CT. Float switches with electric proximity switches in their guide rods are available through Madison Company in Branford, CT.

The advantage of this pump control are as follows: There are no pneumatic timers, which saves in maintenance since pneumatic timers are sensitive to contaminants, such as oil, water and particles in compressed air. Also the pump control design can be made more robust and less expensive than those using timers by using common pneumatic valves and electro-pneumatic valves.

Other electric, pneumatic and electric/pneumatic component arrangements are capable of the same pressurization and exhaust cycling of a pump and are easily designed by someone familiar with pneumatic circuitry and electro-pneumatic components.

FIG. 6—Pneumatic Control Schematic for Submersible Pneumatic Canister Pump with Air Exclusion Valve and Float Switch

FIG. 6 shows a schematic of my design of a pneumatic circuit that can be used to control the pumping from a submersible pneumatic canister pump with an air exclusion valve 86. The combination of components shown can alternately pressurize and exhaust the interior of pump 86, which is submerged in exterior liquid 23, thus pumping exterior liquid 23 to another location.

This control comprises compressed air source 18, two-position three-way pump air valve 132 with actuators 134 and 136, variable regulator 52, gauge 54, cycle reset valve 60 with actuators 58 and 62 and air lines 14, 56, 64, 130, 131, 138, and 148. There is no back pressure regulator or back pressure gauge shown, since they may not be necessary if compressed air source 18 can supply sufficient pressure and flow of air.

Pump 86 is similar to that in FIG. 2 with the exception that it has in addition float 142 with magnet 144 attached or riding on float guide 143. Float 142 with magnet 144 float on interior liquid 24 and follows the level of interior liquid 24. Float guide 143 is mounted near the upper end of the interior of pump 86. Located near the top of float guide 143 is pneumatic proximity switch 140 that pressurizes air line 138 when the level of interior liquid 24 rises, float 142 approaches the top of float guide 143 and brings magnet 144 in proximity to pneumatic proximity switch 140. When float 142 moves from the upper area of guide 143 due to the falling level of interior liquid 24, switch 140 exhausts the compressed air in air line 138 out of pneumatic proximity switch exhaust air line 148. Thus magnet 144 constitutes a switching means incorporated into float 142 that operates pneumatic proximity switch 140 when float 142 is in proximity with switch 140. Float 142 with magnet 144, guide 143, and pneumatic proximity switch 140 are shown internal to pump 86. These components can alternatively be located externally of pump 86.

Compressed air source 18 supplies compressed air through air line 131 to pump air valve 132, regulator 52, cycle reset valve 60, and pneumatic proximity switch 140. Regulator 52 is set to a pressure that will allow exterior liquid 23 to be pumped by pump 86 to a desired discharge location. That pressure is read on gauge 54.

When compressed air source 18 is connected to air line 131, compressed air flows from regulator 52, through regulated air line 56 to actuator 58, shifting reset valve 60 and causing air line 130 to exhaust and remove air pressure from actuator 134. If valve 132 is initially in exhaust mode, the air pressure in hose 14 will be exhausted and exterior liquid 23 can enter pump 86. When pump 86 is nearly full, float 142 will rise from float stop 146 and travel up float guide 142 to position magnet 144 close to pneumatic proximity switch 140, causing switch 140 to pass compressed air through air line 138. The compressed air in air line 138 pressurizes actuator 136, shifting pump air valve 132 to pass compressed air into hose 14 and pressurize the interior of pump 86. This moves interior liquid 24 out of pump 86.

As the level of interior liquid 24 falls in pump 86, float 142 falls and moves magnet 144 away from switch 140. Switch 140 then exhausts the air in air line 138 and removes pressure from actuator 136. Valve 132 continues to pass compressed air to pump 86 until actuator 134 is pressurized. When the level of interior liquid 24 in pump 86 reaches valve 33, valve 33 closes to prevent air and interior liquid 24 from leaving pump 86. This causes the air pressure in pump 86 and air hose 14 to rise. This pressure is transmitted via air line 64 to actuator 62.

After the pressure in air line 64 rises sufficiently to overcome the preset pressure coming from regulator 52 into actuator 58, cycle reset valve 60 shifts to allow compressed air to flow through air line 130 to actuator 134, shifting pump air valve 132 to exhaust air from air hose 14. This allows pump 86 to again fill. Thus the combination of regulator 52, cycle reset valve 60 and actuators 58 and 62 constitute a preset pressure sensing means causing said compressed air to be exhausted from said sealed casing allowing said liquid to be pumped to again enter said pump.

If, when compressed air source 18 pressurizes air line 131, valve 132 is initially in position to pass compressed air to pump 86 through hose 14, pump 86 will not fill because the air inside is not able to leave via hose 14. In this case the first cycle will be a pressure cycle, once compressed air source 18 is connected to the system. The air delivered to pump 86 through hose 14 will force interior liquid 24 that is in pump 86 out, lowering the level of interior liquid 24. This will cause float 142 to move downward, in turn causing pneumatic proximity switch 140 to exhaust air line 138 and removing air pressure from actuator 136. When the level of interior liquid 23 falls to the level of valve 33, valve 33 will close, causing the pressure inside of pump 86 to rise. The pressure in pump 86 and air hose 14 will rise until the pressure in line 64 pressurize actuator 62 sufficiently to overcome the air pressure in air line 56, shifting cycle reset valve 60 to pressurize actuator 134 through air line 130. This causes valve 132 to shift and exhaust hose 14, allowing the interior of pump 86 to depressurize and again fill. The exhaust cycle will continue until the level of interior liquid 24 in pump 86 raises float 142 near the top of float guide 146. The exhaust and pressurization cycles are thus automatically alternately operated causing pump 86 to pump exterior liquid 23.

Magnetically actuated proximity valves are available through H. Kuhnke, Ltd. of Andover, England.

### Advantages

The pump control has no timers, thus reducing initial costs and maintenance.
The pump control contains only two air valves, which are normally more robust than other designs that include timers.
The pump and control system is totally pneumatic and thus no electrical source is required. Electrical power can be hazardous, especially in areas with possible flammable atmospheres or liquids, such as on a refinery.
In addition the control can be made very compact and relatively simple so assembly and maintenance costs are reduced.

Other pneumatic component arrangements are capable of the same pressurization and exhaust cycling of a pump and are easily designed by someone familiar with pneumatic circuitry.

FIG. 7—Offset Discharge Pipe

FIG. 7 shows discharge pipe 15 with an offset section of discharge pipe 150 connected to air exclusion valve 33 such that the assembly is centered in casing 11. Air exclusion valve 33 is constructed and operates as described in FIGS. 2 and 3. Discharge pipe 15 is offset in the area of air exclusion valve 33 to allow discharge pipe 15 to be aligned with casing centerline 152 above and below air exclusion valve 33. Offset section of discharge pipe 150 is connected to air exclusion valve 33 via 90° elbow 31 creating fluid passage 39.

The advantage of offsetting discharge pipe 15 in the area of air exclusion valve 33 is that it positions discharge pipe 15 in the center of casing 11 at the bottom and top of casing 11. It thus allows the use of off-the-shelf parts, because most pneumatic pumps have discharge tube 15 aligned with the centerline 152 of the casing 11. It also makes the machining of the top and bottom ends of a pump easier, as the largest hole is centered and can be bored on a lathe.

Offset section 150 can be made as a separate part and installed in a standard canister pump that would accommodate the extra section by merely shortening discharge pipe 15 or lengthening casing 11. Offset section 150 can be attached to discharge pipe 15 by threads, welding or other means.

FIGS. 8A and 8B—Radial Air Exclusion Valve

FIG. 8A shows a top view of an air exclusion valve manifold block 160 that is bored at several locations Section line 188 indicates the plane on which FIG. 8B is taken.

Air exclusion valve manifold block 160 contains center bore 165. Bored radially inward around the exterior of air exclusion valve manifold block 160 are several of radial cross bore 170. The extremity of each radial cross bore 170 contains threads 171. Several of small vertical bore 183 are formed around the periphery of the upper face of block 160 with each concentrically located within one large vertical bore 180. Each of the small bore 183 intersects a cross bores 170, which intersects with center bore 165. The base of large bore 180 creates ball seat 185.

FIG. 8B shows a sectioned side view of air exclusion valve manifold block 160 in exploded assembly within pump casing 11. A sectional view of threaded ball cage 215 is shown above mating threads 187 located at the upper end of large vertical bore 180. Floating ball 220 is shown inside threaded ball cage 215. Threaded ball cage 215 is shown with screen 218, threads 217, and protective cap 216 with air opening 197. Threaded discharge pipe 162 is shown above mating threads 167 located at the upper end of center bore 165. Threaded nipple 190 is shown below mating threads 169 in the lower end of center bore 165 and above threaded coupling 195. Threaded coupling 195 is secured and sealed in pump casing 11 through casing penetration 198. Threaded inlet check valve 210 is shown in exploded view below mating threads 196 in threaded coupling 195. Threaded plug 173 is shown adjacent to mating threads 171 located at the outer end of cross bore 170.

Center bore 165 passes through block 160 and has threads 167 and threads 169 located at the top and bottom ends respectively. Radial cross bore 170 intersects with small vertical bore 183 and center bore 165, forming internal liquid passage 175 which permits interior liquid 24 to flow between center bore 165 and bore183. Large vertical bore 180 is concentric with small vertical bore 183 and does not extend sufficiently to intersect cross bore 170, thus forming ball seat 185. Pump casing 11 is shown submerged in exterior liquid 23.

Threaded plug 173 is threaded into threads 171 at the outer end of bore 170 to seal the radial extremity of cross bore 170. Discharge pipe 162 is threaded into threads 167 at the upper end of block 160. The upper end of nipple 190 is threaded into threads 169 in the lower end of center bore 165. The lower end of nipple 190 is threaded into the upper end of coupling 195 that passes through casing penetration 198 and is secured and sealed to casing 11. Inlet check valve 210 is threaded into the lower end of coupling 195. Cage 215 with ball 220 inside is threaded into threads 187 in the upper end of large vertical bore 180. Ball 220 is of such a size as to easily travel in, out and within cage 215 to be able to rest on seat 185 and thus prevent interior liquid 24 from passing downward.

When casing 11 is exhausted of compressed air, interior liquid 24 that has exited inlet check valve 210 passes up into bore 165 of block 160, into internal liquid passage 175 and up through bore 183 and bore 180, lifting ball 220 from seat 185, carrying ball 220 up into cage 215 and up into protective cap 222 that has air opening 197 to allow air to escape and permit ball 220 to enter protective cap 222. When casing 11 is pressurized, interior liquid 24 flows through screen 218, down through cage 215, large vertical bore 180 and small vertical bore 183, through passage 175 and up discharge pipe 162 and out of casing 11. When the level of interior liquid 24 in casing 11 nears block 160, floating ball 220 follows the level of interior liquid 24 downward, leaving protective cap 215 to eventually rest on seat 185 to prevent interior liquid 24 and compressed air from being discharged through discharge pipe 162.

The advantages to this embodiment are that it allows discharge pipe 162 to be located in the center of casing 11. This arrangement allows easier assembly than offsetting discharge pipe 162 to allow room for the type of air exclusion valve as shown in FIG. 2. With such a radial arrangement of multiple passages the cross-sectional area available for the flow of interior liquid 24 could be greater than could be achieved by previously discussed embodiments. This allows a higher pump rate to be achieved.

Other piping and machined part arrangements are capable of the same performance to one familiar with the piping and liquid flow.

### CONCLUSIONS, RAMIFICATIONS AND SCOPE

Accordingly the reader will see that my pump embodiments have one or more advantages:
The air exclusion valve in combination with piping for allowing liquid flow to and from a discharge pipe in a pneumatic canister pump prevents compressed air and other gases that have entered the pump from being pushed up the discharge tube with the liquid in the pump, thus reducing turbulence in the liquid being discharged.
Similarly oxygen contact with the liquid being pumped is reduced, lessening the likelihood of adverse chemical reactions.
Also the chance that oxygen may mix with fumes from the liquids being pumped and other gases in the well is reduced, thus reducing the likelihood of a flammable or explosive mixture being created.
Further the controls need only one timer instead of the two that are normally used, thus reducing costs since pneumatic timers can be much more expensive than typical air valves.
The controls need only one pneumatic timer instead of the two that are normally used, thus reducing possible problems because pneumatic timers are more prone to failure than most pneumatic air valves.
Timers are not required to operate submitted embodiments of submersible, pneumatically-driven canister pumps.
Compressed air pressure in the pump can be used to actuate the exhaust/fill cycle of the pump. This ability is unique to the field.
The setting of the controls by a technician is much simpler since there is no need to be careful setting a one- or two-timer control that governs the pressurization and exhaust cycles of the pump.
Many sites use timer controls to operate submersible pneumatic canister pumps that can discharge compressed air with the fluid being pumped. With the present design users can replace only the pump and maintain the controls to gain the advantage of not having compressed air discharged with the fluid being pumped. Thus it would be advantageous to the industry to have a submersible canister pump design that can work with timer controls that do not allow air discharge with fluid to occur.
Insofar as I am aware, there are no submersible pneumatic canister pump designs working with timer controls or other external controls that have incorporated an internal air exclusion valve to prevent air from being discharged with the fluid. Thus the present design is unique to the industry and of great commercial value.

Thus it is seen that the various embodiments provide a pump and control system with one or more of the following advantages: novelty, economical, highly reliable, increased safety, reduction of maintenance for controls and downstream discharge equipment. The various embodiments have the capacity to successfully pump liquid without air being introduced to the liquid discharge stream.

While the above description contains many specifics, these should not be construed as limiting the scope of the embodiments, but as merely providing illustrations of some of several embodiments. For example, a pneumatic valve may be actuated instead of an electrical switch when used in combination with the float at the top of the pump. Such pneumatic float switches are available from Kenco Engineering Co. of Tulsa, Okla.

Those skilled in the art will envision many other possible variations are within its scope. Accordingly the reader is requested to determine the scope by the appended claims and their legal equivalents, rather than by the examples given.

1-26. (canceled)

27. A pneumatically driven canister liquid pump that prevents compressed air from accompanying discharged liquid, comprising:
a. a sealed casing having upper and lower ends with an interior volume into which exterior liquid to be pumped can enter and from which interior liquid to be discharged can be pumped;
b. at least one discharge pipe in liquid connection to said sealed casing, said discharge pipe having an interior liquid passage, an upper end and a lower end for conveying said interior liquid from the interior volume of said sealed casing;
c. at least one inlet check valve for allowing said exterior liquid into said sealed casing and preventing said interior liquid from flowing out of said sealed casing;
d. at least one discharge check valve for allowing said interior liquid out of said sealed casing and preventing discharged liquid from flowing into said casing;
e. at least one passage through a wall of said sealed casing for allowing compressed air (a) into said sealed casing to pressurize the interior of said sealed casing, and (b) out of said sealed casing to exhaust the interior of said sealed casing;
f. at least one air exclusion valve in fluid connection with said discharge pipe for preventing said compressed air from flowing out of said sealed casing through said discharge pipe-and into said discharged liquid; and,
g. piping between said air exclusion valve and said discharge pipe through which said interior liquid can pass,
whereby when said sealed casing is submerged in said exterior liquid and said compressed air is alternately allowed out of the interior of said sealed casing to exhaust said sealed casing and into said sealed casing to pressurize the interior of said sealed casing, (a) said exterior liquid passes into said casing through said inlet check valve and said interior liquid is pumped out of said sealed casing via said discharge pipe and said discharge check valve, and (b) said compressed air is prevented from being transmitted out of said sealed casing through said discharge pipe and said discharge check valve into said discharged liquid.

28. The pump of claim 27 wherein said air exclusion valve includes a ball and seat located near said lower end of said discharge pipe.

29. The pump of claim 27 wherein said air exclusion valve includes a ball and seat and said seat is mounted so that said seat faces said upper end of said sealed casing.

30. The pump of claim 29 wherein said air exclusion valve includes a cage above said seat and said ball is confined by said cage extending above said seat.

31. The pump of claim 27 wherein said air exclusion valve is located internally of said sealed casing.

32. The pump of claim 27 wherein the number of air exclusion valves exceeds one and said multiple air exclusion valves are arranged radially around said discharge pipe.

33. The pump of claim 27 wherein said discharge pipe is offset from the centerline of said sealed casing in the area of one or more of said air exclusion valve.

34. A pump and pump control for pumping liquid comprising,
a. a sealed casing having upper and lower ends with an internal volume;
b. inlet check valve means for allowing exterior liquid to be pumped to flow into said sealed casing, and preventing interior liquid to be discharged from said sealed casing from flowing out of said sealed casing;
c. an outlet check valve means for allowing said interior liquid to be pumped out of said casing through a discharge pipe and prevent discharged liquid from flowing into said casing;
d. a sealing float of lower density than said interior liquid to be discharged;
e. a sealing seat for said sealing float;
f. a liquid connection between said sealing seat and said discharge pipe for allowing flow of said interior liquid to be discharged between said sealing seat and said discharge pipe;
g. third valve means for allowing compressed air into said sealed casing to pressurize said internal volume of said sealed casing;
h. fourth valve means for exhausting said compressed air out of said internal volume of said sealed casing;
i. pressurization and depressurization means for alternately pressurizing and exhausting said internal volume of said sealed casing with said compressed air;
whereby said exterior liquid to be pumped is alternately allowed into said sealed casing and said interior liquid to be discharged is forced out of said sealed casing through said discharge pipe using said compressed air without allowing said compressed air to exit said pump via said discharge pipe.

35. The pump and pump control of claim 34 wherein said discharge pipe is offset in the area of said sealing seat.

36. The pump and pump control of claim 34, further including a valve for passing compressed air with a preset activation pressure bias initiation means for sensing air pressure in said casing and for beginning an exhaust cycle of said pump when air pressure in said casing exceeds said preset bias activation pressure of said valve.

37. The pump and pump control of claim 34, further including at least one timer in said pressurization and depressurization means.

38. The pump and pump control of claim 34, further including at least one float operably connected to a valve arranged to start a pressure cycle of said pump when the level of said liquid in said sealed casing nears the upper end of said sealed casing.

39. A pump and pump control comprising,
a. a sealed casing having upper and lower ends;
b. an inlet check valve in fluid connection between the interior of said sealed casing and the exterior of said sealed casing for allowing liquid to be pumped to flow into said sealed casing through said inlet check valve and prevent interior liquid to be discharged from flowing out of said inlet check valve;
c. a discharge pipe having an exterior end and interior end with said exterior end being exterior to said sealed casing and said interior end being interior to said sealed casing;
d. an outlet check valve for allowing said interior liquid to flow out said sealed casing and not allow discharged liquid to flow into said sealed casing through said outlet check valve;
e. a first float of lower density than said interior liquid;
f. a sealing seat for said first float located internally of said sealed casing and near said lower end of said sealed casing;
g. piping in liquid connection between said sealing seat and said discharge pipe;
h. means for allowing compressed air into the interior of said sealed casing;
i. means for exhausting said compressed air out of said interior of said sealed casing;
j. a second float of lesser density than said interior liquid that is raised to said upper area of said sealed casing as the level of said interior liquid rises inside of said sealed casing;
k. a switch located near said upper end of said sealed casing;
l. means, connected to said second float, for operating said switch when said second float is in proximity to said switch;
m. at least one valve responsive to the operation of said switch causing compressed air to pass into said sealed casing to pressurize said sealed casing and cause said interior liquid to flow through said sealing seat, through said discharge pipe and out of said sealed casing;
n. a preset pressure sensing means for causing said compressed air to be exhausted from said sealed casing and for allowing said liquid to be pumped to enter said sealed casing;
whereby when said pump is submerged in said liquid to be pumped, said liquid to be pumped is allowed into said sealed casing, and said interior liquid rises near said upper area of said sealed casing moving said second float in proximity with the upper end of said sealed casing and in proximity to said switch, causing said compressed air to enter into said sealed casing, thereby forcing said interior liquid to flow through said discharge pipe and out of said sealed casing and subsequently to begin an exhaust cycle of said pump when the falling level of said interior liquid inside said sealed casing causes said first float to rest on said sealing seat causing air pressure in said sealed casing to rise above the preset pressure value of said preset pressure sensing means.

40. The pump and pump control of claim 39 wherein said pressure sensing means comprises an electric pressure transducer having a preset bias, pressure sensing means for sensing air pressure in said pump and valve control means for operating an electro-pneumatic valve for causing compressed air to be exhausted from said casing and beginning an exhaust cycle of said pump when said air pressure in said pump overcomes said preset bias of said pressure transducer.

41. The pump and pump control of claim 39 wherein said switch comprises a pneumatic proximity switch.

42. The pump and pump control of claim 41, further including a magnet operably connected to said second float for operating said proximity switch.

43. The pump and pump control of claim 39 wherein said switch comprises a proximity electric switch.

44. The pump and pump control of claim 43, further including a magnet connected to said second float for operating said proximity electric switch.

45. A method for pumping liquid comprising:
a. providing a submersible pump submerged in liquid to be pumped, said pump having a sealed casing with first means for allowing said liquid to be pumped into said casing through an entry port, and not allow interior liquid to be discharged out of said casing through the entry port, and second means in liquid connection to a discharge pipe for allowing said interior liquid out of said casing through an exit port, and not allow discharged liquid into said casing through the exit port, said submersible pump having means for preventing compressed air from being discharged from said pump with said interior liquid;
b. providing a pump control for alternately supplying said compressed gas to said casing and exhausting said compressed gas from said casing to create a pressurization cycle and an exhaust cycle to the interior of said casing;
c. alternately pressurizing said casing with said compressed gas and exhausting said casing of said compressed gas to alternately force said interior liquid from said casing and after said interior liquid is forced from said casing, allow said liquid to be pumped to again enter said casing;
whereby said liquid to be pumped is transported from one location to another without allowing said compressed gas to exit said casing via said discharge pipe with said interior liquid.

46. The method for pumping liquid of claim 45 wherein said means for preventing compressed air from being discharged from said pump with said interior liquid is a float-sealing means.

47. The method for pumping liquid of claim 45 wherein said pump control is arranged to sense pressure inside said casing and end said pressurization cycle and begin said exhaust cycle when said pressure inside said sealed casing exceeds a preset value established in said pump control.

48. A method for pumping liquid comprising:
a. providing a submersible pneumatic canister pump with an interior and exterior and an upper and lower end submerged in exterior liquid, said pump containing a first valve with a first float of lighter density than interior liquid, said first float arranged to seal said first valve when the level of said interior liquid in said pump nears the lower end of said pump so that said first valve prevents air and said interior liquid from leaving said pump, a float-operated switch and a second float, also of lighter density than said interior liquid, having an upper limit of travel and a lower limit of travel so that said second float causes said float-operated switch to operate as said second float travels to and from said upper limit of travel and said lower limit of travel,
b. sensing the pressure within the interior of said pump
c. providing a pump control for alternately supplying compressed air to said pump and exhausting said compressed air from the interior of said pump to create a pressurization cycle and an exhaust cycle of the interior of said pump, said pump control arranged to end said pressurization cycle and begin said exhaust cycle when said sensed air pressure inside said pump exceeds a preset value established in said pump control and to end said exhaust cycle and begin said pressure cycle after said second float rises near said upper limit of travel,
d. alternately pressurizing and exhausting the interior of said pump with compressed air to alternately force said interior liquid from said pump and allow said pump to again fill with said exterior liquid in which said pump is submerged,
whereby said exterior liquid is pumped from one location to another without allowing compressed air to exit said pump with said interior liquid.

49. The method for pumping liquid of claim 48 wherein said float-operated switch is pneumatic.

50. The method for pumping liquid of claim 49 wherein said float-operated switch is-activated via a magnet in proximity to said switch.

51. The method for pumping liquid of claim 48 wherein said float-operated switch is electric.

52. The method for pumping liquid of claim 51 wherein said float-operated switch is activated via a magnet in proximity to said switch.

53. a pump control for operating a submersible canister pump for pumping fluid and having an air exclusion valve comprising:
a. a compressed air source;
b. an air pressure regulator set to pass compressed air at a predetermined pressure;
c. a pump air valve having a sensor,
d. a pneumatic timer having a sensor reactive to air pressure so that, when pressurized to a predetermined pressure, said timer starts a timer cycle or delay, which, when complete, allows compressed air to pass to the sensor of said pump air valve;
e. a two-position valve with two independent sensors, each sensor being reactive independently to air pressure and each sensor driving said two-position valve to one of two positions, depending upon which sensor has a greater air pressure applied, so that pressurized air from said regulator drives said two-position valve to a first position, and pressurized air from the interior of said pump drives said two-position valve to a second position, and when said two-position valve is in said first position, it passes air to said pneumatic timer sensor and in said second position it exhausts air from said pneumatic timer sensor; and
f. said pump air valve sensor being reactive to air pressure so that, at a predetermined air pressure from said timer, said pump air valve allows compressed air to pass to the interior of said canister pump and when said pump air valve sensor is depressurized, it exhausts air pressure from the interior of said canister pump,
said pump air valve being connected to said compressed air source and arranged to be connected to the interior of said canister pump and one of said sensors of said two-position valve, said air pressure regulator being connected between said compressed air source and one of said two sensors of said two-position valve, said timer being connected between said compressed air source and said sensor of said pump air valve, said two-position valve being connected between said compressed air source and said timer sensor,
whereby when said two-position valve is in said first position said timer sensor is pressurized and said timer cycle commences and compressed air from the interior of said pump is exhausted, allowing said pump to fill with fluid, and when said timer cycle ends, compressed air is passed to the interior of said pump, thus causing said pump to discharge fluid and eventually causing the air pressure inside said pump to rise above the pressure of the air exiting from the regulator, thereby shifting said two-position valve to said second position, exhausting air from said timer sensor and thereby exhausting air from said pump air valve sensor and thus exhausting air from interior of said pump and when the air pressure in said pump is below the air pressure exiting said regulator, said two-position valve shifts back to said first position so that said timer sensor is again pressurized, causing said timer cycle to begin again, allowing said pump to again fill with fluid, thus automatically alternating fill and discharge cycles of said pump.
